(19) United States
(12) Patent Application Publication
(10) Pub. No.: US 2002/0154214 A1
(43) Pub. Date: Oct. 24, 2002

(54) Virtual reality game system using pseudo 3D display driver

(76) Inventors: Laurent Scallie, Honolulu, HI (US); Cedric Boutelier, Brest (FR)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/011,027

(22) Filed: Nov. 2, 2001

Related U.S. Application Data
(60) Provisional application No. 60/244,795, filed on Nov. 2, 2000.

(51) Int. Cl. H04N 13/04

(52) U.S. Cl. 348/51

(57) ABSTRACT

A virtual reality game system and method uses pseudo drivers to generate stereo vision outputs for a 3D stereoscopic display from game software normally intended for output to a 2D display of a conventional game console or PC. The Pseudo Drivers can convert the game data output of 3D video game software written in different application programming interface (API) formats commonly used for PC games to “stereo vision”, thereby allowing hundreds of existing 3D games to be played on a virtual reality game system. The intercepted 3D game data can be stored in a 3D data recorder for later play back. The 3D game data can also be transmitted or downloaded to a remote player through an online interface. The intercepted 3D game data can be combined with other 3D content through a mixer and dual rendering system, which facilitates control of the 3D display before, during, and after a game, and particularly when switching between different games. The Pseudo Driver for the 3D display can be operated in tandem with other pseudo drivers such as for stereo sound and\or directional force feedback.

### SPECIFICATION

This U.S. patent application claims the priority benefit of U.S. Provisional Application No. 60\244,795 filed on Nov. 2, 2000, entitled “Pseudo 3D Driver for Controlling 3D Video Program”, by the same inventors in common with the present application.

### TECHNICAL FIELD

This invention generally relates to virtual reality game systems which provide a three-dimensional (3D) immersive experience to game players, and more particularly, to a method for using pseudo drivers to create 3D game displays for 3D games and applications.

### BACKGROUND OF INVENTION

Commercial virtual reality games are currently played at VR game stations with one or more players. To create an immersive environment without the high cost of installing surrounding wall displays in large room environments, the commonly used VR game station typically provides a VR game that is played by a player wearing stereoscopic goggles or other 3D head-mounted display (HMDs) and manipulating a weapon or other action equipment while executing physical motions such as turning, aiming, crouching, jumping, etc., on a platform or cordoned space. The VR games played on conventional VR game stations typically are written for the specific, often proprietary, hardware and operating systems provided by manufacturers for their VR game stations. As a result, there are only a limited number of VR games available for play at current VR game stations.

Players of VR games often want to play games that are popular video games they are used to playing on game consoles or PCs. Even though many video games are written to create 3D game effects, the common video game console or PC hardware supports image displays for 2D monitors or TV screens. While the 2D displays allow the viewer to view the image in simulated 3D space, it does not provide the immersive depth of vision of a true 3D experience. It is as if the viewer is seeing the 3D image with only one eye. Popular video games therefore are not used at VR game stations employing stereoscopic 3D displays unless the publishers of those video games have chosen to write versions for operation on the hardware and operating systems used at VR game stations of the different manufacturers.

It would therefore be very desirable to have a VR game system in which popular 3D video games written to be displayed on 2D display hardware can be operated to provide a 3D stereoscopic display without having to re-write the video game software for the 3D display hardware. It would also be very useful for a new VR game system to enable other 3D game services for VR game players based upon popular video games they want to play on VR game stations.

### SUMMARY OF INVENTION

In accordance with the present invention, a method (and system) for operating three-dimensional (3D) application software intended to provide output to a two-dimensional (2D) screen display comprises:

(a) running the application software in its normal mode to generate 3D application data output which is normally to be sent to an application programming interface (API) driver for the 2D screen display;

(b) intercepting the 3D application data output from the application software and redirecting the data to a pseudo driver for generating a 3D stereoscopic display; and

(c) using the pseudo 3D display driver to generate a 3D stereoscopic display.

In a preferred embodiment, the 3D application is a 3D video game, and the 3D stereoscopic display is a set of head-mounted stereo vision goggles used in a virtual reality (VR) game system. The VR game system employs the pseudo 3D display driver to convert 3D game data from existing 3D video game software intended for 2D screen display to right and left stereoscopic image data for the 3D stereoscopic display. Conversion to stereo vision requires the generation of specific right and left image viewpoints which are combined by human vision to yield an immersive 3D image. The Pseudo Driver converts the 3D game data output of the video game software in any of the application programming interface (APT) formats commonly used for popular video games to an API format that supports the handling of stereoscopic image outputs, thereby allowing hundreds of existing 3D video games to be played in a commercial VR game system. The invention method can also be used to generate 3D stereoscopic displays for games played on video game consoles or PCs for home use.

As a further aspect of the invention, the intercepted 3D game data can be stored by a 3D data recorder for later play back. In this mode, a game player can replay a game or scene of a game they previously played, or another player can re-enact the game played by another player. The 3D game data can also be transmitted or downloaded to a remote player through an online interface. This would allow the replay of the player's 3D visuals at home or on other hardware platforms without the original game software (like replaying previously recorded video).

The intercepted 3D game data being re-directed to the Pseudo Driver can also be overlaid, edited, or combined with other 2D or 3D images through a mixer for real-time enhancement of the resulting displayed 3D content. Examples include high-score rewards, promotional information, and logo animation before, during, and after a game or mission.

The Pseudo Driver for the 3D stereoscopic display can also be operated in tandem with other pseudo drivers such as drivers for stereo sound and\or directional force feedback.

Other objects, features, and advantages of the present invention will be explained in the following detailed description of the invention having reference to the accompanying drawings.

### BRIEF DESCRIPTION OF DRAWINGS

FIG. 1A is a block diagram illustrating the overall invention method of intercepting 3D game data and using pseudo 3D display drivers for generating a 3D stereoscopic display, and FIG. 1B is a block diagram illustrating a preferred method for operation of the pseudo driver through the use of the “dll wrapper” method.

FIG. 2A is a diagram illustrating the conventional API function call for a 2D display from a first type of PC game (OpenGL) software, as compared to FIG. 2B illustrating the pseudo API call for generating a 3D stereoscopic display.

FIG. 3A is a diagram illustrating the conventional API function call for a 2D display from a second type of PC game (Glide) software, as compared to FIG. 3B illustrating the pseudo API call for generating a 3D stereoscopic display.

FIG. 4A is a diagram illustrating the conventional API call for a 2D display from a third type of PC game (DirectX) software, as compared to FIG. 4B illustrating the pseudo API call for generating a stereoscopic display.

FIG. 5 is a diagram of a virtual reality (VR) game system using pseudo 3D display drivers to drive dual graphics cards for generating a 3D stereoscopic display for different types of PC game software.

FIG. 6 is a diagram of a VR game system using pseudo 3D display drivers to drive a single dual-head graphics card for generating a 3D stereoscopic display for different types of PC game software.

### DETAILED DESCRIPTION OF INVENTION

In the following description of the invention, a 3D application software generates 3D application data intended for rendering to a 2D display, but the 3D application data are intercepted and rendered by pseudo drivers for a 3D display instead. In a preferred implementation, the 3D application is a 3D video game, and the 3D display is a stereoscopic display device. The advantages of this implementation are described in terms of the capability of configuring a commercial virtual reality (VR) game system (with multiple pods) to offer players their choice of many popular video games in an immersive VR mode with stereo vision. However, it is to be understood that the principles of the invention disclosed herein apply equally to other types of games, programs, and 3D applications, including, for example, CAD applications, simulation applications, and the like, as well as to other use environments, such as home use, standalone PCs, networked game stations, and online (Internet) gaming.

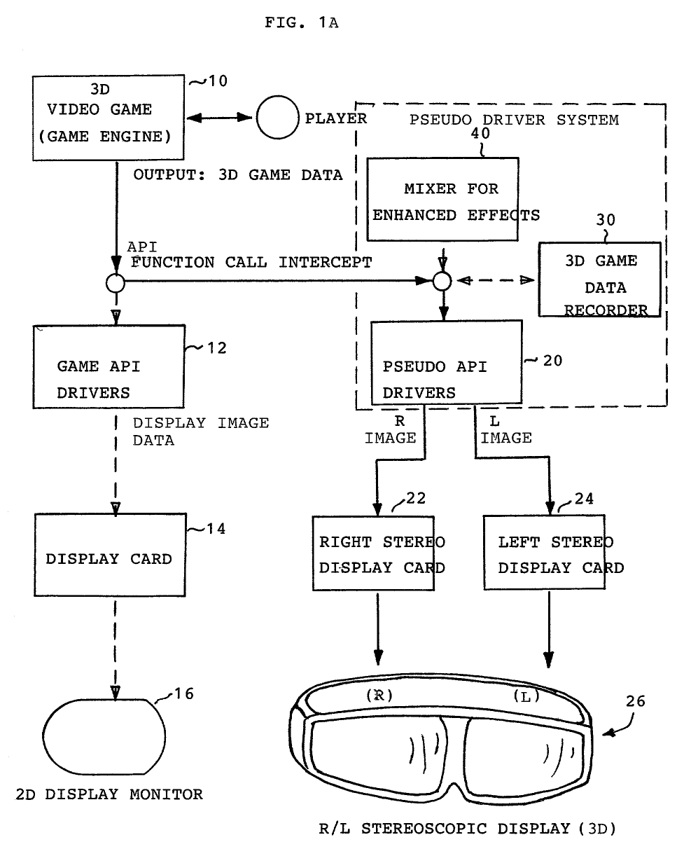

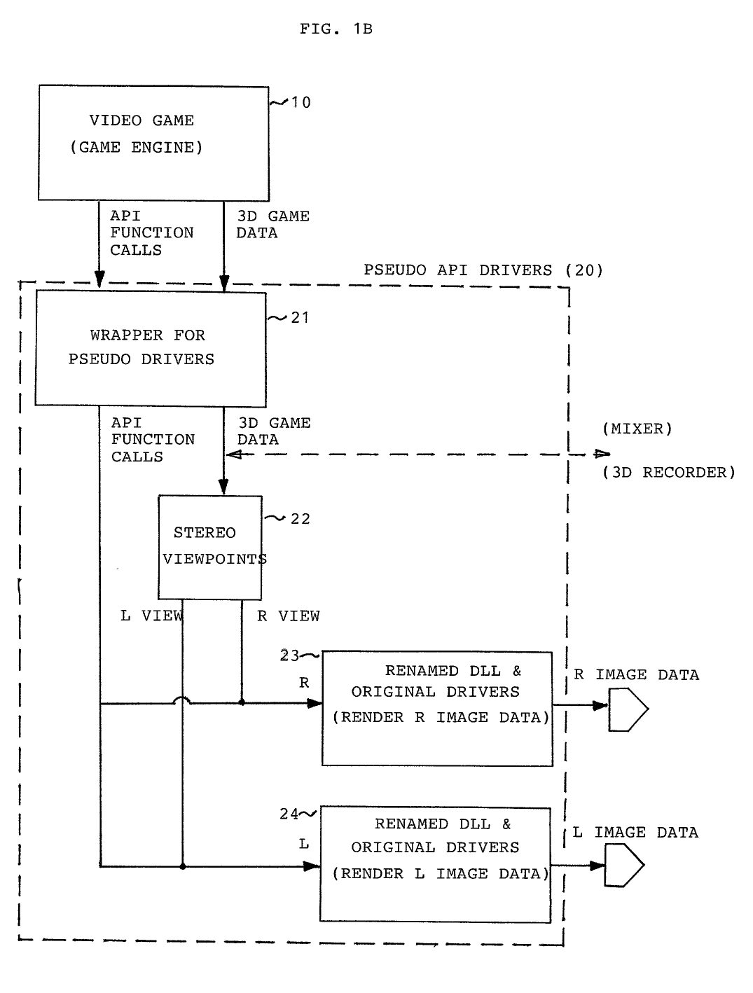

Referring to FIG. 1A, the basic method and system of the present invention is illustrated for playing one of many popular 3D video games that a player may want to play in 3D vision. The existing (previously written) 3D video game software 10 is played by a Player and generates a stream of 3D visuals through a game engine that outputs 3D game data. Video games are written using one of several common Application Programming Interfaces (API) for handling the rendering and display functions of the game. In a conventional mode (dashed arrows), the 3D game data (series of polygons making up image objects to appear in scenes, and light, shading, and color data) are output with API function calls to conventional API drivers 12, which render the 3D game data into display image data that are fed to a graphics display card 14 and result in a 2D image displayed on a 2D display monitor 16.

In the present invention (solid line arrows), the 3D game data output of the video game software 10 are intercepted and redirected to pseudo API drivers 20 which generate right (R) and left (L) stereoscopic image outputs to right and left stereoscopic display cards 22, 24 that generate the resulting 3D stereoscopic display on a 3D display device 26. “Stereo vision” refers to immersive visual images which provide depth perception to the viewer. Depth perception is obtained by delivering appropriate right and left offset images to the user's right and left eyes.

The API function calls intercepted and re-directed to the Pseudo API Drivers 20 result in the intercepted 3D game data output being processed to R\L image data that can be viewed on a 3D display device, such as VR goggles, helmet, or “no glasses required” 3D monitor. In order to use any of the hundreds of existing PC games, the Pseudo Drivers are written to handle the common API formats used for PC games, such as Glide (TM), developed by 3dfx Interactive, Inc., of Alviso, Calif., OpenGL (TM), developed by Silicon Graphics, Inc., (SGI) of Mountain View, Calif., or DirectX (TM), distributed by Microsoft Corp., of Redmond, Wash.

As illustrated in FIG. 1B, the invention method intercepts and redirects the API function calls and 3D game data output from the existing 3D video game software 10 to Pseudo API Drivers 20. In the preferred implementation shown using the so-called “dll wrapper” method (specific examples described in detail below), the Pseudo Drivers 20 consist of a Wrapper 21 which is given the same name in the System directory as the dynamic link library (“dll”) for the original API drivers (“Original Drivers”), while the original dll is renamed under a different name and maintained with the Original Drivers. When the video game software is initialized, it calls the dll for the API drivers in its usual mode. Due to its assumption of the original dll name, the Wrapper 21 is called instead of the original dll and drivers and effectively intercepts the API function calls and 3D game data of the video game software. The Wrapper 21 establishes a Stereo Viewpoints module 22 and sets up parallel R and L rendering engines from the renamed original dll and drivers, one rendering engine 23 for rendering right (R) image data, and the other rendering engine 24 for rendering left (L) image data. The Wrapper 21 sends the 3D game data to the Stereo Viewpoints module 22 where right (R) and left (L) viewpoints are calculated or specified for the 3D game data, resulting in R View data and L View data. The API function calls are directed by the Wrapper 21 to the R rendering module with the R view data, resulting in rendering the R image data, and to the L rendering module with the L view data, resulting in rendering the L image data. The R and L image data are then sent to the R and L display cards for the 3D stereoscopic display (see FIG. 1A).

In the invention, the Pseudo Driver intercepts the 3D game data between the game and the API. The 3D game data can thus be rendered into stereo vision for any specified viewpoint.

In the conventional mode by contrast, the data stream from the game goes to the API which is specific to the video card, and undergoes rendering and transformation to an image fixed as 2D. The Pseudo Drivers of the invention method intercept the game data stream and invoke the same (or comparable) rendering functions to render the 3D game data into 3D stereoscopic image data, by generating specific right and left image viewpoints. The right and left image data are sent as outputs to the display cards 22 and 24, which then generate the respective bit-mapped image outputs to activate the display elements in the corresponding right and left eyepieces of the stereoscopic display unit 26. In the preferred embodiment shown, two separate display cards are used for the two stereoscopic image feeds for greater processing speed and throughput.

Computational methods for generating right and left stereoscopic images from given image data are well known, for example, as described in “3d Stereo Rendering Using OpenGL (and GLUT), by Paul Bourke, November 1999, available at the Internet page http:\\astronomy.swin.edu.au\bourke\opengl\stereogl\. The method of determining the right and left eye offset and computing corresponding left and right eye images is deemed to be conventional and not described in further detail herein.

Referring again to FIG. 1A, an integrated Pseudo Driver system can also include a 3D game data recorder 30 (3D Recorder) for storing the 3D game data for later playback, and a mixer 40 for enhancing the 3D content, such as by overlaying, editing, or combining with other 2D or 3D images. The 3D Recorder 40 records the 3D game data stream (vertices, polygons, textures, etc.) for subsequent playback without the need to re-access the game software, such as for providing visuals while debriefing players after a game session or for replaying for a player's personal use. The mixer 40 allows other images, 2D or 3D, to be mixed or interspersed with the game images. For other 3D content, the mixer 40 takes the form of a dual rendering module which renders the other 3D content and combines it with the game content. It is advantageous to record 3D game data with the 3D Recorder between the Pseudo Driver Wrapper and the mixer (dual rendering module), because all API types will have been converted into the chosen 3D image data format (DirectX 8, as explained below). Using data compression techniques, the large amount of data can be minimized and stored to disk. The data stream can be played back by simply sending it to the dual rendering module. If the data stream is sent to the 3D Recorder between the game and the Pseudo Drivers, then the game data can be played back simply by sending it to the corresponding API.

Because of the separation between the Wrapper 21 and the mixer (dual rendering module) 40, the mixer can always be running. This allows the system total control of the display at all times, and avoids any lapse in the display if, for example, control is switched to another game. When the next game is run, the API Wrapper called by the new game re-connects with the dual rendering module.

Use of Existing Game Software in VR Systems

State-of-the-art first person games are composed of a “game engine”, an object-oriented scriptable logic, and game “levels”. The game engine is the essential technology that allows for 3D graphics rendering, sound engine, file management, networking support and all other aspects of the core application. The content of the game sits on top of the rendering engine in the form of scripts and levels basically setting up the series of scenes and actions (“world map”) forming the visual environment and the logic within it.

Tools provided by game developers are available for modification of the scripted logic of the various objects in the world map, as well as generation of new environments. For PC games, this allows for new content to be created by game developers and the life cycle of the game to be significantly greater. The current trend in game development is to license a specific game engine and allow game developers to focus on content creation, the concept and implementation of the levels, sounds, models, textures and game logic. Using those editing tools, customized game environments can be produced, characters created, weapons and game objects designed, and special game logic implemented to create the desired game content.

Conventional 3D video games are written to be run on conventional hardware and operating systems for display on a 2D monitor, and thus the conventional experience is basically 2D. The 3D game data executes function calls to conventional API drivers for the game that result in a 2D screen image being generated. The conventional game system renders a 3D scene as a centered 2D image as if the user were viewing it with one eye. It is desirable to use existing 3D games for play in VR systems that engage players with a 3D stereo vision display for a more immersive game experience. Since the existing games output 3D game data, the 3D game data can be converted to a 3D display. However, mere connection of a 3D monitor to a standard 3D game like Quake3 (TM), distributed by Activision, Inc., ______, Calif., would not yield a stereo vision image. Doubling a centered image using 3D display hardware also would not yield a stereo image. Only the generation of specific right and left image viewpoints for stereo vision will yield a correct stereo image on a 3D display unit.

3D display technology includes, but is not limited to, HMDs, no-glasses-required monitors, LCD glasses, and hologram display units. Typically, all of these hardware types require two separate 2D input images, one for each eye. Each new type of 3D display technology comes with its own 3D format. Typically, they conform to one of the following standard formats (from highest quality to lowest quality): separate right and left (R\L) images; frame sequential images; side-by-side (left\right) images; top-and-bottom (over\under) images; or field sequential (row interleaved) image signals.

The highest quality stereo vision signal is simply two separate R\L image signals. The remaining methods use some method of compression to pack both left and right signals into a single signal. Because of this compression, and overloading of a single signal, the stereo vision image quality is lowered, and\or the frame rate is lowered. The lower quality, “single signal” methods are typically used by lower-priced stereovision hardware, like LCD glasses. Some hardware vendors, such as nVidia Corp., of Santa Clara, Calif., have recently provided support for single-signal, stereo vision formats. For example, the nVidia stereo vision drivers are contained within the nVidia video card-specific driver, nvdisp.drv. The nVidia driver effectively converts a 3D game written for DirectX or OpenGL to be viewable in stereo vision using any single-signal 3D device that is connected to the nVidia video card. However, these card-specific drivers only work if the manufacturer's video card is used. Conventional hardware manufacturers do not support card-independent high-end, separate right and left image signals.

Another important aspect of the invention is the interception of the data stream at the game-API level. Conventional stereovision drivers are established between the API and the video card, and the code existing between the API and the video card requires hardware-specific code. Drivers on that level need to be made by the manufacturer of the video card hardware, which is a drawback in a game system that offers many different games using the same video card hardware. Another drawback is that the data has already undergone a 3D game data to 2D image data transformation, and is therefore fixed as 2D. Once the data are converted to 2D, the 2D data can be converted to stereovision only with “less visually accurate” mathematics.

In the preferred embodiment of the invention, two separate video cards 22 and 24 are used for the separate right and left signal inputs of high-end 3D display devices. Doubling the number of video cards allows for the right and left stereo image to be rendered separately and simultaneously. This avoids the typical 2x slowdown required to display stereo rather than mono. The Pseudo Driver thus allows a normal 3D game to power two video cards, which in turn can power high-end 3D display hardware such as V6 or V8 (TM) Stereovision Head Mounted Displays, distributed by Virtual Research Systems, Inc., of Santa Clara, Calif., Visette (TM) Stereovision Head Mounted Display, distributed by Cyber Mind, Ltd., of Leicestershire, UK, Datavisor (TM) Stereovision Head Mounted Display, distributed by N-Vision, Inc., of McLean, Va., or DTI 2015XLS or 2018XLQ (TM) Stereovision Monitor, distributed by Dimension Technologies, Inc.

Pseudo 3D Display Drivers

In the present invention, the 3D game data output of existing game software are intercepted and re-directed to Pseudo Drivers for 3D display in place of the conventional API drivers for 2D display. The Pseudo Drivers execute the same or comparable image rendering functions but generate the specific right and left image viewpoints required by 3D display devices. The Pseudo Drivers only convert the 3D game output of the game software and do not affect or manipulate the game software itself. Thus, the Pseudo Drivers can produce a 3D display from conventional 3D game software without requiring access to or modification of the game source code.

3D display technology has developed to offer very high resolution and wide field of view. When used with a head mounted display unit (HMD) which allows direct head tracking, VR systems can offer a very immersive virtual reality experience for the player. Other 3D display devices that may be used include 3D monitors, such as the DTI3D (TM) monitor distributed by Dimension Technologies, Inc., of Rochester, N.Y., which delivers a stereo vision image without requiring the use of stereoscopic glasses. Most new 3D display technology can be hooked up to games running on standard Intel-based PCs with the Microsoft Windows (TM) operating system.

Typical graphics API's have some 400 functions that the game program can call to render 3D polygonal scenes. These functions, generally speaking, have names like LoadTexture, SetTexture, RenderPolygons, Display Image, etc. All of the API's functions are held in a dynamic link library (dll). The API's .dll is stored in the computer's C:\Windows\System directory. Depending on which API format it is written for, a game will automatically load the appropriate .dll stored in the System directory, and the functions contained within are used to render the game's 3D world map to the 2D screen. The API converts the data internally, and forwards the data to the video card-specific driver. The driver optionally modifies the data further into a format specific to the current video card hardware. The video card renders the data to the screen in the form of textured polygons. The final image appears on the user's monitor as a 2D projection of the 3D world map.

The Pseudo Driver of the present invention intercepts the data being sent from the game to the API. The simplest method to do this borrows from a technique called “.dll wrapping”.

In this method, a “Pseudo API” is named and substituted for the usual original API for which the game issues the display function calls. That is, the Pseudo API assumes the identity of the usual API's .dll that the game is looking for. This substitution is done at the installation level for the VR system by storing the Pseudo API in the System directory in place of the original API. When the game executes function calls for the API, the Pseudo API is called and intercepts the 3D game data. The data stream between the game and the rendering API consists of thousands of vertices, polygons, and texture data per frame. The Pseudo API then either executes calls, or issues subcalls to the original APIs which are set up to be running in the background, for the usual rendering functions, then passes the rendered data to the Pseudo Driver matched to the type of 3D display unit used in the VR system. The Pseudo Driver generates the card-independent R\L stereoscopic image signals which are passed as inputs to the 3D display unit.

Example: Pseudo OpenGL Driver

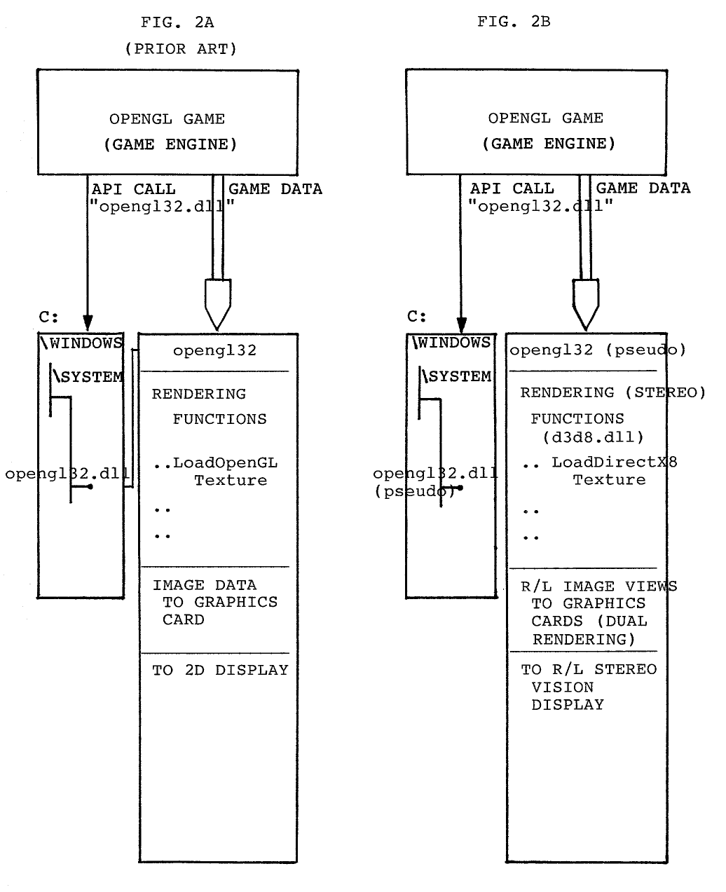

Many popular PC games are written for OpenGL API, such as Quake3. As illustrated in FIG. 2A (Prior Art), the game run in conventional PC-based mode initializes with an API call for the OpenGL dynamic link library, called “openg132.dll”, stored in the C:\Windows\System directory. The game software loads the openg132.dll, then sends the stream of game data generated by play of the game to opengl32.dll for linkage to the appropriate API drivers for rendering the game's series of scenes to the 2D screen. The API drivers render the game data to image data and sends the image data to the graphics card used by the API to drive the 2D display.

As shown in FIG. 2B, a Pseudo OpenGL Driverhas awrappernamed “openg132.dll” is substituted in the System directory in place of the OpenGL .dll formerly of that name. When Quake3 is run, it calls for the “openg132.dll” and binds with the Pseudo OpenGL Wrapper that was substituted. In this case, the OpenGL API is never actually initialized; in fact, it is not needed on the machine at all. The Pseudo OpenGL Driver linked to the psuedo OpenGL wrapper pretends to be the OpenGL driver, however, all the data sent to it is converted into a format that can be rendered for stereo vision by a dual rendering system for the dual R\L stereoscopic image outputs. DirectX 8 is used as the rendered data format since it can support the use of multiple outputs to multiple graphics cards. For about 370 functions, some translation and\or redirection is required. Generally speaking, only about 20% of the functions are actually used by games. Each of these functions has a small amount of code that is translated. Translation could be as simple as calling “LoadDirectX 8Texture”, when “LoadOpenGLTexture” is called, for example. The DirectX 8 calls are linked through the real DirectX 8 .dll (“d3d8.dll”). Other functions require large amounts of code that converts vertex, index, or texture data. All the game data is handled in this way by the Pseudo Driver. The Pseudo Driver effectively ports Quake3 for OpenGL and 2D display to DirectX 8 for stereoscopic display without touching Quake3 source code. An example of the source code for the Pseudo OpenGL Wrapper is provided in Appendix A.

Example: Pseudo Glide Driver

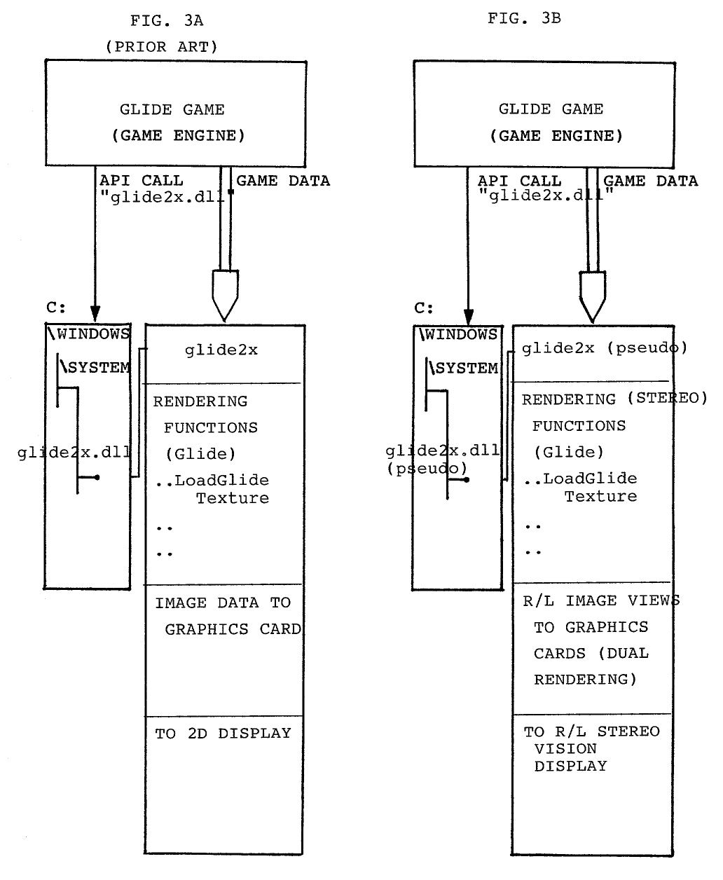

The Glide API has been used in many popular games, but is no longer being supported. A Glide-only Pseudo Driver was created for use only for Glide games. Glide is technically unusual in that it allows access to multiple graphics cards (but only if 3dfx cards are used). This made the creation of the Glide Pseudo Driver easier than for OpenGL which does not allow access to multiple video cards. As before, FIG. 3A (Prior Art) shows a Glide game run in conventional mode for a 2D display, and FIG. 3B shows the Glide game run in pseudo wrapper mode for a 3D display. Source code for a Pseudo Glide2x.dll wrapper was written, and stored in the C:Windows\System directory. The Pseudo Glide wrapper exports the same rendering functions as the real Glide2x.dll. From the outside, the two .dlls are indistinguishable. As a result, when a Glide game such as Unreal Tournament is run, it loads the Pseudo Glide2x.dll from the C:Windows\System directory. The game Unreal Tournament then sends game data to the Pseudo Glide wrapper, which manipulates the data, changing it into a format for stereoscopic display to two video cards for the right and left image viewpoints. An example of the source code for the Pseudo Glide Wrapper is provided in Appendix B.

Example: Pseudo DirectX Driver

Many popular games today, such as Unreal Tournament, are written for DirectX 7 or earlier versions or have the option to render using DirectX 7. The Pseudo Driver system is set up to use DirectX 8, because DirectX 8 can support multiple hardware devices. Therefore, games written for DirectX 7 uses a pseudo wrapper which provides for conversion from DirectX 7 to DirectX 8. Games written for DirectX 8 can use a pseudo wrapper which links to the real DirectX 8 functions and the required further links for generation of the R\L stereo vision outputs.

DirectX uses a linking structure named Common Object Method (COM), which is a different method of storing functions inside dynamic link libraries. Therefore, the Pseudo DirectX wrapper was written to handle the COM link structure. The code for the DirectX COM wrappers is more complex than the OpenGL, or Glide wrappers. For example, in the openg132.dll structure, all of the rendering functions are accessible to OpenGL programmers. However, the DirectX COM structure has an initial index which only points to 3 categories of functions, as follows:

ValidatePixelShader

ValidateVertexShader

Direct3DCreate8

The category index has a link structure which points to the actual rendering functions one layer deeper. When a DirectX 8 game initializes, the DirectX API named “d3d8.dll” is loaded. The game must first call the Direct3DCreate8 function, which returns a class pointer. This class pointer can then be used to access all DirectX 8 rendering functions. Thus, in addition to the standard .dll wrapper, the pseudo DirectX wrapper handling the COM method also requires a wrapper for the class. An example of the code for a Pseudo DirectX Wrapper handling the COM method and one example of a rendering function are appended in Appendix C.

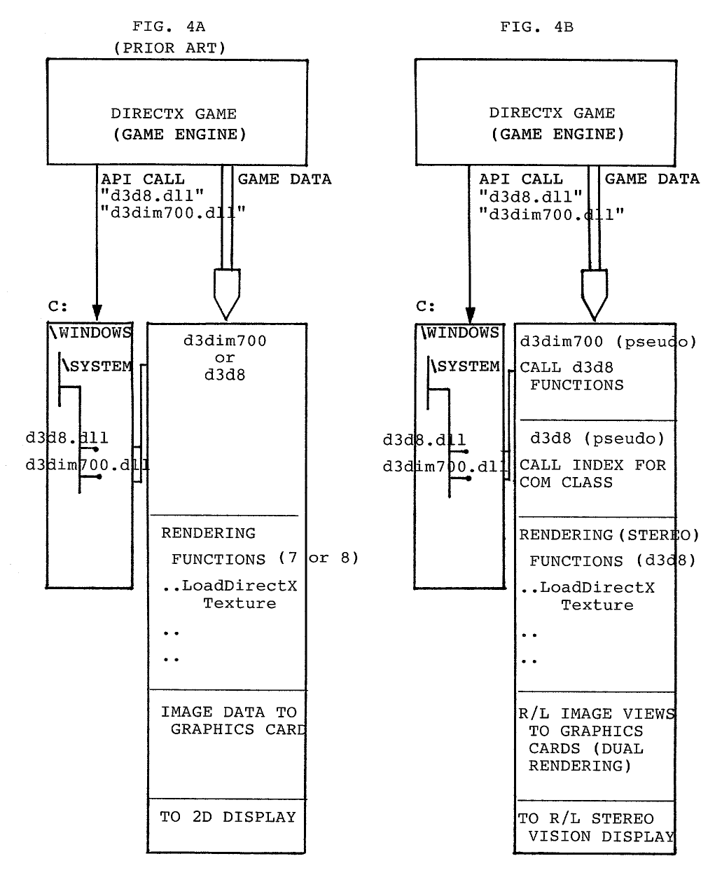

FIG. 4A (Prior Art) shows a DirectX game run in conventional mode for a 2D display, and FIG. 4B shows the DirectX game run in pseudo wrapper mode for a 3D display. Source code for a Pseudo DirectX wrapper was written, and stored in the C:Windows\System directory. There are actually two DirectX wrappers stored, one for the DirectX 7 .dll named “d3dim700.dll” for games written for DirectX 7, and one for DirectX 8 .dll named “d3d8.dll” for games written for DirectX 8. The pseudo d3dim700.dll converts DirectX 7 function calls and data into DirectX 8 function calls, whereas the pseudo d3d8.dll links directly to DirectX 8 function calls. The Pseudo DirectX wrapper renders the game data into a format for stereoscopic display to two video cards for the right and left image viewpoints.

Integration of Pseudo 3D Display Drivers in VR Game System

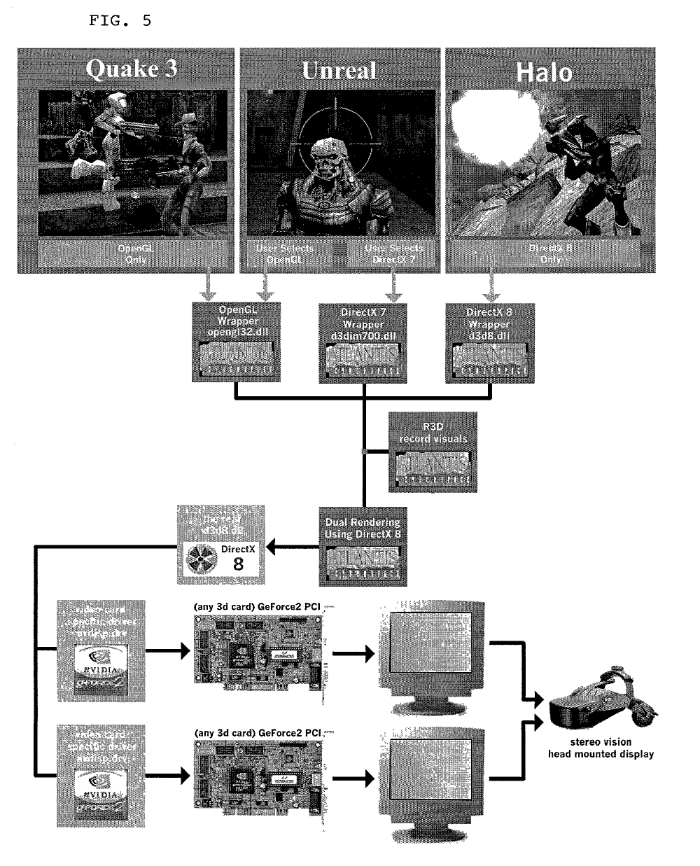

Referring to FIG. 5, an example of the virtual reality game system is shown incorporating pseudo 3D display drivers for existing PC games to generate a stereo vision display. The system can accommodate most of the popular games that are written for OpenGL, DirectX 7, and\or DirectX 8. Pseudo OpenGL, DirectX 7, and DirectX 8 wrappers take the 3D game data output of any of the games and re-directs them to Dual Rendering links to real DirectX 8 rendering functions. The resulting R\L stereo image outputs are fed to dual graphics cards, which are nVidia GeForce2 cards using the card-specific driver nvdisp.drv in this example. The separate R and L image display outputs are fed to the respective R and L eyepieces of a stereo vision head mounted display. A parallel system can be configured for Glide games using a Pseudo Glide wrapper and Glide-specific graphics cards.

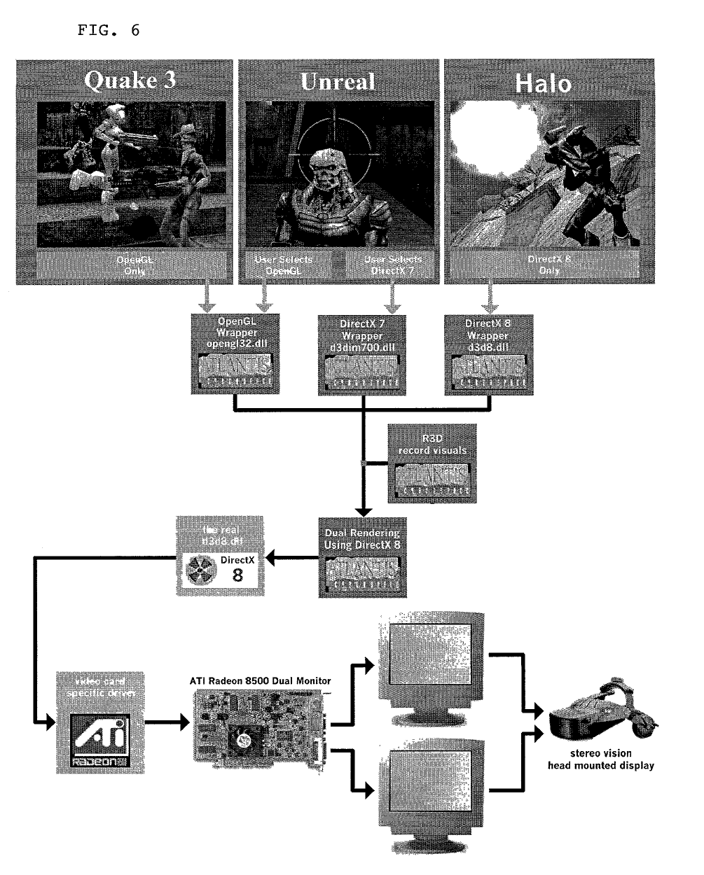

FIG. 6 shows an alternate configuration in which the R\L stereo image outputs are fed to a single dual-head graphics card, which is an ATI Radeon 8500 Dual Monitor card in this example. The single “dual head” card has 2 VGA monitor-capable outputs. Some of the cards components, like the PCI interface for example, are shared between the two devices. As a result, the single card solution is slower than the same system with dual cards. Thus, the dual-head system offers a tradeoff of somewhat lower performance against a lower cost than the two-card system.

Extremely high-end stereo devices take two inputs, one for each eye. Typically, the two inputs are provided from two separate video cameras to achieve stereoscopic vision in the final 3D display. In the invention, the Pseudo Driver instead provides a high-end synthetic connection to the 3D display through the re-direction of 3D game data to dual rendering functions and dual graphics cards to provide the two stereoscopic images. Each card (or card head) renders a slightly different image, one from the viewpoint of the left eye, and the other from the viewpoint of the right eye. Because both frames are rendered simultaneously, the typical 2x stereo vision slowdown is avoided. This allows regular PC games like Quake3 to be viewable in stereo vision using the latest 3D display technology.

The pseudo driver methodology enables an integrated VR game system to be played for most of the popular PC games known to players, and allows integration of related functions that can take advantage of its game data interception and dual rendering functions. Some of these system integration features and advantages are described below.

Pseudo Driver Architecture: The pseudo driver software architecture allows interfacing of VR input and output devices to a 3D game application without its source code. Pseudo drivers are drivers or applications that lie between the game application and the actual legitimate video, sound, input or output driver. The VR system wraps existing applications with a series of pseudo drivers.

Generic (Game-Independent) Stereo Vision Display: The pseudo driver method generically allows creating a quality depth perception display from any 3D application without needing to access its source code and regardless of the API (Glide, DirectX, or OpenGL). The outputs are two separate high quality VGA signals with no compromise in frame rate or resolution. It is not an interlaced output.

Generic (Game-Independent) Recording Engine: Since the 3D Recorder records 3D game data output from any Glide, DirectX, or OpenGL applications, it can replay the visuals of a player's game in high quality 3D vision without needing to run the original application. One of the further advantages of this is that the recorded data can be replayed on any DirectX capable player, making it possible to use an online interface allowing members to download their mission replay to their home hardware platform.

Generic (Game-Independent) Video Overlay Graphics: By leveraging the architecture of the pseudo driver, it becomes possible to fully control and even enhance the 3D game output though a mixer. The game visuals can be overlaid with other 3D content or animation, text and graphics in real time. Examples include high-scores, promotional information, and logo animation before, during or after a mission.

Native Head Tracking Support: The pseudo driver methodology allows PC games to be played as VR games using head-mounted devices. The HMDs allow for head tracking in real-time inside a game environment with 3 degrees of freedom (looking up\down, left\right and tilting) without access to the game source code. Native versus mouse emulation tracking allows for zero lag and high-resolution positioning, ultimately increasing quality immersion and reducing motion sickness. A critical benefit of native tracking is that the user does not experience head recalibration since horizontal in real space is known by the device in this mode only.

Duo Tracking Support: Use of HMDs frees up the player's hands to control aweapon or other type of action device. Currently, 3D consumer games only support a single 2 degrees of freedom input device (mouse, trackball, and joystick). The VR system can support two 3-degrees-of-freedom tracking devices via a combination of external drivers and game script modification. In duo tracking (head tracking and weapon tracking), a player will be able to look one way and shoot the other for example.

Peripheral Input Engine: This tool enables the system to interface a variety of input devices like guns, buttons on the POD, pod rail closure sensors and the like to the 3D game or the mission control software.

Pseudo Sound & Force Feedback Drivers: A pseudo sound and\or force feedback driver can be added in tandem with the pseudo 3D display driver. This would allow real-time filtering of sounds and generating accurate force feedback for custom designed hardware like a force feedback vest. The vest can have a number of recoil devices that would be activated based on the analysis of the nature and impact locations of ammunition in the virtual opponents. For example, a rocket contact from the back would trigger all recoil devices at once, while a nail gun hitting from the back to the front as one is turning would be felt accurately by the user. Further applications of the pseudo driver method could include an intercom localized in the 3D environment and replacement or addition of game sound with other sounds.

Other features and advantages of the integrated VR game system are described in commonly owned U.S. patent application No. 09\______ , filed on the same date, entitled “Mission Control System for Game Playing Satellites On Network”, which is incorporated herein by reference.

It is understood that many modifications and variations may be devised given the above description of the principles of the invention. It is intended that all such modifications and variations be considered as within the spirit and scope of this invention, as defined in the following claims.

APPENDIX A
C:\Documents and Settings\jhuggins\Local Settings\Temporary Internet Files\OLK4\Operl0/3l/2001 6:00PM
//this is an example of intercepting an opengl call, and converting it into dual Direct3d8.
//This is one of the simplest examples possible.
//Some functions dont require much work at all.
//Other functions require extremly complex data conversion.
//this ClearDepth function, happens to be very similar to its d3d8 equivalent function
// we know the vol for (0-1) which is same for input of d3d8's clear function.
// thus no conversion off data required, just redirection.
// If any conversion is required, it is done inside Opengl32.cpp.
//-------------------------------------------------------------------------------------------------------------
//OPENGL32.CPP
//header for real function, written by SGI OpenGL.
void (_stdcall* real_glClearDepth) (GLclampd depth);
//During init, we retrieve a pointer to the real opengl function
real_glClearDepth = (void(_stdcall*) (GLclampd depth))GetProcAddress (DLLInst,“glClearDepth”);
//inside our opengl32.dll wrapper, our pseudo function looks like this :
_declspec(dllcxport) void _stdcall glClearDepth(GLclampd depth)
{

if (convertTOd3d8)
{//actively converting stream into d3d8dual

//preform any necessary data conversion here.
d3d_glClearDepth (depth);

}
else
{//pass through, debug mode. normal OpenGL operation.

real_glClearDepth(depth);

)

}
//--------------------------------------------------------------------------------------------------------
//DUAL.CPP
//The opengl32.dll wrapper calls this function provided by our DualRendering System.
void d3d_glClearDepth(float depth)
(

dual_glClearDepth (depth);

}
//the dual glclearDepth issues the commands to the 2 video cards.
void dual_glClearDepth(float depth)
)

if(g_d3ddevl !- NULL)
{

g_d3ddev1->Clear(0,NULL,D3DCLEAR_ZBUFFER,D3DCOLOR_XRGB(0x00, 0x00, 0x00),depth,0);

}
if(g_d3ddev2 !- NULL)
{

g_d3ddev2->Clear(0,NULL,D3DCLEAR_ZBUFFER, D3DCOLOR_XRGB(0x00, 0x00, 0x00),depth,0);

}

)

APPENDIX B
C:\Documents and Settings\jhuggins\Local Settings\Temporary Internet Files\OLK4\Glic10/31/2001 5:00PM
//GLIDE EXAMPLE of dual rendering
//Glide openly allows access to 2 cards by calling grSstSelect(0), or 1
//Glide also doesnt have to worry about “exclusive mode” which only allows 1 full screen DrectX wind
ow.
// So no special code for window creation is necessary.
//Duo to differences in the AFI's, the data at this point has already been transformed from 3D into
2D data.
//As a result, less accurate method of creating stereo image is applied.
// This stereo method moves the geometry (in 2D), rather than the correct method of moving the camer
a.
//Assembly was used to bypass the C/C++ const barrier. In assembly, it is not “read only”
// const means “read only” “you cant modify it legally”
// In assembly language, the “read only” lock is not checked.
// This allows us to move the const geometry.
// The assembly simply adds, or subtracts an offset, based on the geometrys distance from camera.
FX_ENTRY void FX_CALL PgrDrawTriangle(const GrVertex *a,

const GrVertex *b,
const GrVertex *c, float& angle, float& limit)

{

float dista = (a ->oow) * angle;

if ( abs((int)dista) >- abs((int)limit))

dista = limit;

float distb - (b->oow) * angle;

if ( abs((int)distb) >= abs((int)limit))

distb - limit:

float distc = (c->oow) * angle;

if (abs((int)distc) >= abs((int)limit))

distd - limit;

float temporaire = 0.0f;

//On commence par soustraire le decalage

_asm
{

//Premier point
pushad
push ds
mov esi, a
mov eax, [esi]
mov temporaire. eax
fld temporaire
fsub dista
fstp tempotaire
mov eax, temporaire
mov [esi],eax
//Deuxieme point
mov esi,b
mov eax, [esi]
mov temporaire, eax
fld temporaire
fsub distb
fstp temporaire
mov eax, temporaire
mov [esi],eax
//Troisieme point
mov esi,c
mov eax, [esi]
mov temporaire, eax
fld temporaire
fsub distc
fstp temporaire
mov eax, temporaire
mov [esi],eax
pop ds
popad

}

Appendix B
C:\Documents and Setting\jhuggins\Local Settings\Temporary Internet Files\OLK4\Glicl0/3l/2001 5:00PM

dista = 2 * dista;
distb = 2 * distb;
distc − 2 * distc,
_asm
{

//Premier point
pushad
push ds
mov esi, a
mov eax, [esi]
mov temporaire, eax
fld temporaire
fadd dista
fstp temporaire
mov eax, temporaire
mov [esi],eax
//Deuxieme point
mov esi,b
mov eax, [esi]
mov temporaire, eax
fld temporaire
fadd distb
fstp temporaire
mov eax, temporaire
mov [esi],eax
//Troisieme point
mov esi,c
mov eax, [esi]
mov temporaire, eax
fld temporaire
fadd distc
fstp temporaire
mov eax, temporaire
mov [eei], cax
pop ds
popad

}
REAL_grSstSelect (l)
REAL_grDrawTriangle(a, b, c);
//Restoration
dista = dista / 2;
distb = dista / 2;
distc = dista / 2;

_asm

{

//Premier point
pushad
push ds
mov esi, a
mov eax, [esi]
mov temporaire, eax
fld temporaire
fsub dista
fstp temporaire
mov eax, temporaire
mov [esi],eax
//Deuxieme point
mov esi,b
mov eax, [esi]
mov temporaire, eax
fld temporaire
fsub distb
fstp temporaire
mov cax, temporaire
mov [esi],eax
//Troisieme point
mov esi,c
mov eax, [esi]
mov temporaire, eax

Appendix B
C:\Documents and Settings\jhuggins\Local Settings\Temporary Internet Files\OLK4\Glicl0/3l/2001 5:00PM

fld temporaire
fsub distc
fstp temporaire
mov eax, temporaire
mov [esi],eax
pop ds
popad

}

REAL_grSstSelect(0);

APPENDIX C
C:\Documents and Settings\jhuggins\Local Settings\Temporary Internet Files\OLK4\d3d8l0/3l/2001 5:01PM
//Windows specific code for creation of 2 full screen windows
//Function is called twice, once for each display. 2 displays for 2 eyes.
bool WindowCreate( int Id,

HINSTANCE hinstance,
char* pWindowName,
char* pClassName,
HWND& hwnd,
HWND& parenthwnd)

{

| WNDCLASS wc; | |
|---|---|
| wc.style | = 0; |
| if(Id==0) | |
| { | |

| | |
|---|---|
| wc.lpfnWndProc | = (WNDPROC) WndProcl; |

}
else if(IC=-l)
{

| | |
|---|---|
| wc.lpfnWndProc | = (WNDPROC) WndProcl; |

}
else
{

assert (0)

| ) | |
|---|---|
| wc.cbClsExtra | = 0; |
| wc.cbwndExtra | = 0; |
| wc.hInstance | = hInstance; |
| wc.hIcon | = NULL; |
| wc.hCursor | = (HCURSOR) NULL; |
| wc.hbrBackground | = (HBRUSH)COLOR_INACTIVECAPTION; |
| wc.lpszMenuName | = NULL; |
| wc.lpszClassName | = pClassName; |

if (!RegisterClass (&wc))
(

sprintf(pDebugText, “RegisterClass(&wc) FAILED\n”);
OutDebugErrorMsg ();
return false;

)
int thisone = 0;
//this part is critical for Atlantis. Allows 2 FULL SCREEN, Hardware accelerated windows
//the poorly documented W5 POPUP|WS VISIBLE flags make a
// window without borders. ie windowed, but FULL SCREEN
//2 “real” FULLSCREENS is impossible, because first “real” FULLSCREEN sets exclusive mode.
hwnd = CreateWindow(pClassName,

pWindowName,
W5_POPUP|WS_VISIBLE ,
CW_USEDEFAULT,
CW_USEDEFAULT,
ScreenWidth,
ScreenHeight,
parenthwnd,
NULL,
hInstance,
NULL);

// If the main window cannot be created, terminate
// the application.
if (hwnd == 0)
{

sprintf(pDebugText,“hwnd--NULL : FAILED\n”);
OutDebugErrorMsg ();
return false;

}
if (Id--0)
{

//position first window at 0,0 on monitor 1 assumed to be at 640×480

Appendix C
C:\Documents and Settings\jhuggins\Local Settings\Temporary Internet Files\OLK4\d3d810/3l/2001 5:01PM

SetWindowPos(hwnd, HWND_TOPMOST,0,0,ScreenWidth, ScreenHeight,SWP_SHOWWINDOW );

}
else if(Id==1)
{

//position second window at 0,0 on monitor 2 assumed to be at 640×480
SetWindowPos(hwnd,HWND_TOPMOST,ACTUALScreenWidth,0,ScreenWidth,ScreenHeight,SWP_SHOWWINDOW

;

}
return true

}
//D3D8 creation of 2 devices
//debug #defines. allows for programmer to debug system using 1, or 2, or both devices simultaneousl
y.
//for release, both are defined.
// ACCELERATOR 1 AVAILABLE
// ACCELERATOR 2 AVAILABLE
int InitializeHardware(HINSTANCE hInstance)
{

WNDCLASS wc1;
WNDCLASS wc2;
static char *CLASS_NAME1 = “CLASS1”;
static char *CLASS_NAME2 = “CLASS2”;
static char *WINDOW_NAME1 = “Window 1”;
static char *WINDOW_NAME2 − “Window 2”;
DiskFile=fopen(“c:\\backup\\DualTest.TXT”, “w”);
fprintf(DiskFile,“Atlantis Cyberspace\n”);
fclose(DiskFile);
sprintf(pDebugText, “˜InitializeHardware˜\n”);
OutDebugErrorMsg ();
//___________________________________________________________________________________________
HWND DesktopWindow = GetDesktopWindow();
WindowCreate(0,hInstance,WINDOW_NAME1,CLASS_NAME1,g_hwnd1,DesktopWindow);
#ifdef ACCELERATOR_2_AVAILABLE
WindowCreate (1,hInstance,WINDOW_NAME2,CLASS_NAME2, g_hwnd2,g_hwnd1);
#endif//ACCELERATOR_2_AVAILABLE
//___________________________________________________________________________________________
#ifdef ACCELERATOR_1_AVAILABLE
pEnum = Direct3DCreate8(D3D_SDK_VERSION);
if (pEnum == NULL)
{

sprintf(pDebugText,“Direct3DCreate8 Device 1 : FAILED\n”);
OutDebugErrorMsg();
return −1;

}
#endif//ACCELERATOR_1_AVAILABLE
#ifdef ACCELERATOR_2_AVAILABLE
pEnum2 = Direct3DCreate8(D3D_SDK_VERSION)
if (pEnum2 == NULL)
(

sprintf(pDebugText, “Direct3DCreate8 Device 2 : FAILED\n”);
OutDebugErrorMsg ();
return −1;

}
#endif//ACCELERATOR_2_AVAILABLE
//___________________________________________________________________________________________
#ifdef ACCELERATOR_1_AVAILABLE
DeviceCreate(g_hwnd1,pEnum,g_d3ddev1,D3DADAPTER_DEFAULT);
#endif//ACCELERATOR_1_AVAILABLE

Appendix C
C:\Documents and Settings\jhuggins\Local Settings\Temporary Internet Files\OLK4\d3d810/3l/2001 5:00PM

| #ifdef ACCELERATOR_2_AVAILABLE | |
|---|---|
| DeviceCreate (g_hwnd2,pEnum2,g_d3ddev2,1); | |
| #endif//ACCELERATOR_2_AVAILABLE | |
| //___________________________________________________________________________________________ | |
| #ifdef ACCELERATOR_2_AVAILABLE | |
| ShowWindow(g_hwnd1, 5W_SHOWDEFAULT); | |
| UpdateWindow(g_hwndl); | |
| #endif//ACCELERATOR_1_AVAILABLE | |
| #ifdef ACCELERATOR_2_AVAILABLE | |
| ShowWindow(g_hwnd2, SW_SHOWDEFAULT): | |
| UpdateWindow(g_hwnd2); | |
| #endif//ACCELERATOR_2_AVAILABLE | |
| // | ___________________________________________________________________________________________ |

if (g_d3ddev1)
{

g_dlddev1->SetRenderState (D3DRS_LIGHTING, FALSE);
g_d3ddev1->SetRenderState (D3DRS_ALPEABLENDENABLE, FALSE);
g_d3ddev1->SetRenderState (D3DRS_FILLMODE, D3DFILL_SOLID);
g_d3ddev1->SetRenderState (D3DRS_CLIPPING, TRUE);
g_d3ddev1->SetRenderState (D3DRS_ZENABLE, FALSE);
g_d3ddev1->SetRenderState (D3DRS_ZWRITEENABLE, FALSE);
g_d3ddev1->SetTextureStageState (0,D3DTSS_MINFILTER,D3DTEXF_LINEAR);
g_d3ddev1->SetTextureStageState (0,D3DTSS_MACFILTER,D3DTEXF_LINEAR);
g_d3ddev1->SetTextureStageState (0, D3DTSS_MIPFILTER, D3DTEXF_POINT);

}
if(g_d3ddev2)
{

g_d3ddev2->SetRenderState (D3DRS_LIGHTING,FALSE
g_d3ddev2->SetRenderState (D3DRS_ALPHABLENDENABLE, FALSE);
g_d3ddev2->SetRenderState (D3DRS_FILLMODE, D3DFILL_SOLID);
g_d3ddev2->SetRenderState (D3DRS_CLIPPING,TRUE);
g_d3ddev2->SetRenderState (D3DRS_ZENABLE,FALSE);
g_d3ddev2->SetRenderState (D3DRS_ZWRITEENABLE, FALSE);
g_d3ddev2->SetTextureStageState(0,D3DTSS_MINFILTER,D3DTEXF_LINEAR):
g_d3ddev2->SetTextureStageState(0,D3DTSS_MAGFILTER,D3DTEXF_LINEAR);
g_d3ddev1->SetTextureStageState(0,D3DTSS_MIPFILTER,D3DTEXF_POINT);

| } | |
|---|---|
| InitializeTextureManager (); | |
| dual_RestoreVertexBuffers (); | |
| ResetBindTextureOrderList (); | |
| d3d_InitMatrixStack(&g_ModelViewBlack ); | |
| d3d_InitMatrixStack(&g_ProjectionStack); | |
| g_Viewport.X | = 0; |
| g_viewport.Y | = 0; |
| g_Viewport.Width | = 640; |
| g_Viewport.Height | = 480 |
| g_Viewport.MinZ | = 0.0; |
| g_Viewport.MaxZ | = 1.0; |
| return 0; | |

//This function is one off many that handle the rendering.
// Other functions similar to this one ere : RenderTriangle, RenderQuad, RenderTriangleStrip. . . etc.
Appendix C
C:\Documents and Settings\jhuggins\Local Settings\Temporary Internet Files\OLK4\d3d810/31/2001 5:01PM
//the global variables g d3ddevl, and g d3ddev2 are pointers to IDirect3DDevice8.
//a IDirect3DDevice8 can be thought of as the last software interface to the video card.
//most commands are issued twice.
//After a g d3ddev command is issued, it immediatly returns, so that execution can continue.
// This allows for concurency. The first card starts rendering, ans the second card is receiving da
ta.
// At some point, they are both rendering, and Intel CPU is free to continue doing other things, wh
ile video cards render to their own memory.
void RenderTriangleFan(MYVERTEX2* pVertices,long num_verte)
{

if(g_d3ddevl != NULL)
{

assert (state_d3ddevl==1);

}
if(g_d3ddev2 != NULL)
{

assert (state_d3ddev2--1);

}
HRESULT Error = S_OK;
HRESULT hr = S_OK;
MYVERTEX2 Quad[1024];
long i;
//////////////////////////////////////////////////////////////////////////
if(g_d3ddev1 = NULL)
{

FrameCounter++;
g_d3ddevl->SetVertexShader(D3DFVF_D3DVERTEX);

#ifdef USE_SET_TEXTURE

g_d3ddev1->SetTexture( 0, p_gl_TEXTURE[c_glBindTexture].pD3DTexture0);

#endif

if(max_num_verts<num_verts)
{

max_num_verts=num_verts;

}
if(bWriteToForground)
{

g_d3ddevl->SetRenderState(D3DRS_ZENABLE,TRUE);
g_d3ddevl->SetRenderState(D3DRS_ZWRITEENABLE,FALSE);

)
else if(bWriteToBackground)
(

g_d3ddevl->SetRenderState(D3DRS_ZENABLE,TRUE);
g_d3ddevl->SetRenderState(D3DRS_ZWRITEENABLE,FALSE);

}
else
{

g_d3ddevl >SetRenderState(D3DRS_ZENABLE, bZBufferRead)
g_d3ddevl->SetRenderState(D3DRS_ZWRITEENABLE,bZBufferWrite);

}

#ifdef RENDER_POLYGONS

hr = g_d3ddevl->DrawPrimitiveUP(D3DPT_TRIANGLEFAN,num_verts-2,pVertices, sizeof{MYVERTEX2));
total_num_verts += num_verts;
total_num_tris += num_verts-2;

#endif//RENDER_POLYGONS

if(FAILED(hr))
{

sprintf(pDebugText, ”g_d3ddevl->DrawPrimitiveUP : FAILED\n”);
OutDebugErrorMsg ();
GetError(hr);
OutDebugErrorMsg ();

}

}
//////////////////////////////////////////////////////////////////////////
if(g_d3ddev2 != NULL)
{

FrameCounter++
g_d3ddev2->SetVertexShader(D3DFVF_D3DVERTEX);

Appendix C
C:\Documents and Settings\jhuggins\Local Settings\Temporary Internet Files\OLK4\d3d810/31/2001 5:01 PM
#ifdef USE_SET_TEXTURE

g_d3ddev2->SetTexture( 0, p_gl_TEXTURE[c_glBindTexture].pD3DTexture1);

#endif

if(bWriteToForground)
{

g_d3ddev2->SetRenderState(D3DRS_ZENABLE,TRUE);
g_d3ddev2->SetRenderState(D3DRS_ZWRITEENABLE, FALSE);

}
else if (bWriteToBackground)
{

g_d3ddev2->SetRenderState(D3DRS_ZENABLE, TRUE);
g_d3ddev2->SetRenderState(D3DRS_ZWRITEENABLE, FALSE);

}
else
{

g_d3ddev2->SetRenderState(D3DRS_ZENABLE, bzBufferRead );
g_d3ddev2->SetRenderState(D3DRS_ZWRITEENABLE,bZBufferWrite);

}

#ifdef RENDER_POLYGONS

hr - g_d3ddcv2->DrawPrimitiveUp(D3DPT_TRIANGEFAN,num_verts-2,pVertices,sizeof(MPVERTEX2));
total_num_verts +− num_verts;
total_num_tris += num_verts-2;

#endif//RENDER POLYGONS

if (FAILED (hr))
{

sprintf(pDebugText, “g_d3ddev2->DrawPrimitiveUP : FAILED\n”);
OutDebugErrorMsg ();
GetError(hr);
OutDebugErrorMsg ();

}

)
//////////////////////////////////////////////////////////////////////////
dual_SetZDias (0);

}

1. A method for operating three-dimensional (3D) application software intended to provide a display output to a two-dimensional (2D) screen display comprising:
(a) running the application software in its normal mode to generate 3D application data output which is normally to be sent to an application programming interface (API) driver for the 2D screen display;
(b) intercepting the 3D application data output from the application software and redirecting the data to a pseudo driver for generating a 3D stereoscopic display; and
(c) using the pseudo 3D display driver to generate a 3D stereoscopic display.

2. A method according to claim 1, wherein the 3D stereoscopic display is selected from the group consisting of head-mounted “stereo vision” goggles, head-mounted 3D display device, and a stereo vision monitor.

3. A method according to claim 1, wherein the 3D application software is a 3D video game software which provides 3D game data output.

4. A method according to claim 3, wherein the intercepting and redirecting of the 3D game data is obtained by providing a wrapper for the game software's native API having stereoscopic display function calls linked under the same name as the game software's native API for 2D display.

5. A method according to claim 4, wherein the wrapper supports a selected one of the following group of native API formats: Glide; OpenGL; and DirectX.

6. A method according to claim 1, wherein the pseudo driver generates a 3D stereoscopic display using separate graphics cards for rendering right and left image viewpoints for the 3D stereoscopic display.

7. A method according to claim 1, wherein the pseudo driver generates a 3D stereoscopic display using one graphics card with dual heads for rendering right and left image viewpoints for the 3D stereoscopic display.

8. A method according to claim 3, wherein the intercepted 3D game data is stored in a 3D data recorder for later play back.

9. A method according to claim 8, wherein the recorded 3D game data are transmitted or downloaded through an online interface to a remote user.

10. A method according to claim 3, wherein the intercepted 3D game data is combined with other 3D content using a mixer and a dual rendering system.

11. A method according to claim 10, wherein the dual rendering system is kept running while switching between different game software.

12. A method according to claim 3, wherein another pseudo driver operates on the 3D game data in tandem with the pseudo 3D display driver.

13. A method according to claim 12, wherein the other pseudo driver is a stereo sound or a directional force feedback driver.

14. A method according to claim 12, wherein the video game software is run with one or more tracking devices for input from the player.

15. A 3D display system for operating three-dimensional (3D) application software which makes display function calls to a native API for the software under an API linking name to provide a display output to a two-dimensional (2D) screen display comprising:
(a) a computer for running the application software in its normal mode to generate 3D application data output;
(b) a file directory system for the computer in which the application software's native API is normally stored under the API linking name; and
(c) a pseudo 3D display driver stored in the computer's file directory system under the API linking name as a wrapper in place of the native API for intercepting the display function calls and 3D application data output from the application software and redirecting them through the pseudo 3D display driver in order to generate a 3D stereoscopic display.

16. A 3D display system according to claim 15, wherein the 3D stereoscopic display is selected from the group consisting of head-mounted “stereo vision” goggles, head-mounted 3D display device, and a stereo vision monitor.

17. A 3D display system according to claim 15, wherein the 3D application software is a 3D video game software which provides 3D game data output.

18. A 3D display system according to claim 17, wherein the wrapper supports a selected one of the following group of native API formats: Glide; OpenGL; and DirectX.

19. A 3D display system according to claim 15, wherein the pseudo 3D display driver specifies right and left eye views for the 3D application data output, and sets up parallel rendering engines using the native API for converting the right and left eye views into right and left image data, respectively, which are used for the 3D stereoscopic display.

20. A 3D display system according to claim 19, further including separate graphics cards for rendering right and left image displays for the 3D stereoscopic display.
